(19) United States
(12) Patent Application Publication
(10) Pub. No.: US 2026/0238434 A1
(43) Pub. Date: Aug. 13, 2026

(54) METHODS AND NODES FOR MULTI-LAYER DFT-S-OFDM FOR SINGLE-DCI STxMP

(71) Applicant: TELEFONAKTIEBOLAGET LM ERICSSON (PUBL), Stockholm (SE)

(72) Inventors: Sven JACOBSSON, VÄSTRA FRÖLUNDA (SE); Jianwei ZHANG, SOLNA (SE)

(21) Appl. No.: 19/154,111

(22) PCT Filed: Feb. 15, 2024
(86) PCT No.: PCT/IB2024/051448

§ 371 Date: Aug. 6, 2025

Related U.S. Application Data
(60) Provisional application No. 63/446,425, filed on Feb. 17, 2023.

(51) Int. Cl. H04L 5/00; H04W 72/21

(52) U.S. Cl. CPC H04L 5/0051; H04W 72/21

(57) ABSTRACT

There is provided a method in a User Equipment (UE), equipped with a plurality of panels. The method comprises: receiving, from a network node, a configuration of a plurality of sounding reference signal (SRS) resource sets for physical uplink shared channel (PUSCH) transmissions with multiple layers using Discrete Fourier Transform (DFT)-Spread (S) Orthogonal Frequency Division Multiplexing (OFDM); receiving an indication from the network node, the indication comprising one or more Demodulation Reference Signal (DMRS) ports mapped to the plurality of SRS resource sets; and sending simultaneously a PUSCH transmission based on the indication, from each panel of the plurality of panels, wherein each panel is associated with a SRS resource set of the plurality of SRS resource sets. A UE for carrying out this method is also provided.

### RELATED APPLICATIONS

This application claims the benefits of priority of U.S. Provisional Patent Application No. 63/446,425, entitled “Multi-layer DFT-S-OFDM for single-DCI STxMP” and filed at the United States Patent and Trademark Office (USPTO) on Feb. 17, 2023, which is hereby incorporated by reference in its entirety.

### TECHNICAL FIELD

This application relates to wireless communication networks and more particularly to methods and nodes for multi-layer DFT-S-OFDM for single-DCI STxMP.

### BACKGROUND

### PUSCH (Physical Uplink Shared Channel)

The channel that carries data in the New Radio (NR) Uplink (UL) is called Physical Uplink Shared Channel (PUSCH), which can be dynamically or semi-statically scheduled. In NR, there are two possible waveforms that can be used for PUSCH: Cyclic Prefix-Orthogonal Frequency Division Multiplexing (CP-OFDM) and discrete Fourier transform spread orthogonal frequency division multiplexing (DFT-S-OFDM). The time-and-frequency domain resource allocation of the PUSCH is signaled by the network (NW) to the User Equipment (UE). Furthermore, there are two transmission schemes specified for PUSCH: Codebook-based (CB)-based precoding and non CB (NCB)-based precoding.

### PUSCH Scheduling

UL data transmissions can be dynamically scheduled by a Dynamic Grant (DG) (via Downlink Control Information (DCI) signaling) or semi-statically scheduled by a Configured Grant (CG) (via Radio Resource Control (RRC) signaling).

### PUSCH Waveform

The NW decides which waveform to use for PUSCH via RRC signaling. Specifically, for a PUSCH scheduled by a DG, if the higher-layer parameter transformPrecoder in PUSCH-Config (see an example from 3GPP TS 38.331 version 17.2.0) is enabled, the waveform is DFT-S-OFDM, if it is disabled, the waveform is CP-OFDM. If this field is not present, the UE applies the value of the higher-layer parameter msg3-transformPrecoding in RACH-ConfigCommon.

### CP-OFDM

CP-OFDM is the baseline UL waveform. With CP-OFDM, non-contiguous frequency allocation is possible, which can simplify UL scheduling. CP-OFDM can also make the receiver less complex compared to DFT-s-OFDM (e.g., simplified channel equalization and layer separation) and supports coherent precoding. In NR Rel-17, CP-OFDM supports up to four-layer UL transmission.

### DFT-S-OFDM

The main benefit with DFT-S-OFDM compared to CP-OFDM is that UL coverage can be improved as higher power-amplifier efficiency is possible due to lower cubic metric. Drawbacks with DFT-S-OFDM entails scheduling restrictions as only contiguous allocation in the frequency domain, for which the number of resource blocks (RBs) must be a multiple of 2, 3, and 5, is possible. Furthermore, UL precoding is more restrictive as coherent precoding (i.e., coherent combining of layers over antenna ports) is not possible. In fact, only single-layer UL transmission is supported with DFT-S-OFDM in NR Rel-17.

### PUSCH Precoding

Two transmission schemes are supported: CB-based precoding and NCB-based precoding.

### CB-Based Precoding

With CB-based precoding for the NR uplink, the NW configures the UE to transmit sounding reference signal (SRS) over a number of UE antennas. Based on SRS-based channel measurements, the NW signals a Transmit Precoding Matrix Indicator (TPMI), which indicates the transmission rank and precoder that the UE should apply over the UE antennas when transmitting PUSCH. The precoder candidates are tabulated in Clause 6.3.1.5 of 3GPP TS 38.211.

CB-based PUSCH is enabled if the higher-layer parameter txConfig in PUSCH-Config IE is set to codebook. For dynamically scheduled PUSCH, CB-based PUSCH transmission can be summarized in the following steps.

1) The UE transmits SRS, configured in an SRS resource set with higher-layer parameter usage in SRS-Config IE set to codebook. Up to two SRS resources (for testing up to two virtualizations/beams/panels) each with up to four ports, can be configured in the SRS resource set.
a. The gNB determines the number of layers (i.e., the rank) and a preferred precoder (i.e., TPMI) from a codebook subset based on the received SRS from one of the SRS resources. The codebook subset is configured via the higher-layer parameter codebookSubset_in PUSCH-Config IE (see 3GPP TS 38.331 version 17.2.0), based on reported UE capability, and is one of fully coherent, partially coherent, or non-coherent.

2) If two SRS resources are configured in the SRS resource set, the gNB indicates the selected SRS resource via the 1-bit SRI field in the DCI scheduling the PUSCH transmission. If only one SRS resource is configured in the SRS resource set, the SRI field is not present in the DCI.

3) The gNB indicates, via the DCI field “Precoding information and number of layers”, the number of layers and the TPMI. The maximum number of layers is limited by the higher-layer parameter maxRank in PUSCH-Config IE. Demodulation Reference Signal (DMRS) port(s) associated with the layer(s) are also indicated in DCI via the field “Antenna ports”. Unless UL full-power mode 1 is configured, the number of bits in DCI used for indicating the number of layers (if transform precoding is enabled, the number of PUSCH layers is limited to 1) and the TPMI is determined as follows:
4, 5, or 6 bits if the number of antenna ports is 4, if transform precoding is disabled, and if the higher-layer parameter maxRank in PUSCH-Config IE is set to 2, 3, or 4 (see Table 7.3.1.1.2-2 of 3GPP TS 38.212 version 17.2.0).
2, 4, or 5 bits if the number of antenna ports is 4, if transform precoding is disabled or enabled, and if the higher-layer parameter maxRank in PUSCH-Config IE is set to 1 (see Table 7.3.1.1.2-3 of 3GPP TS 38.212 version 17.2.0).
2 or 4 bits if the number of antenna ports is 2, if transform precoding is disabled, and if the higher-layer parameter maxRank in PUSCH-Config IE is set to 2 (see Table 7.3.1.1.2-4 of 3GPP TS 38.212 version 17.2.0).
1 or 3 bits if the number of antenna ports is 2, if transform precoding is disabled or enabled, and if the higher-layer parameter maxRank in PUSCH-Config IE is set to 1 (see Table 7.3.1.1.2-5 of 3GPP TS 38.212 version 17.2.0).
0 bits if 1 antenna port is used for PUSCH transmission.

4) The UE performs PUSCH transmission over the antenna ports corresponding to the SRS ports in the indicated SRS resource.

The precoding information and number of layers, for 4 antenna ports, with transform precoding being disabled or abled and with different ranks (maxRank) are given in Table 7.3.1.1.2-2, Table 7.3.1.1.2-3, Table 7.3.1.1.2-4, and Table 7.3.1.1.2-5 of 3GPP TS 38.212 version 17.2.0.

### NCB-Based Precoding

NCB-based PUSCH is enabled if the higher-layer parameter txConfig in PUSCH-Config IE is set to nonCodebook and is intended for reciprocity-based UL transmission in which SRS precoding is derived at a UE based on CSI-RS received in the DL. Specifically, the UE measures received Channel State Information (CSI)-Reference Signal (RS) and deduces a suitable precoder for SRS transmission(s), resulting in one or more (virtual) SRS ports, each corresponding to a spatial layer.

A UE can be configured up to four SRS resources, each with a single (virtual) SRS port, in an SRS resource set with higher-layer parameter usage in SRS-Config IE set to nonCodebook. A UE transmits the up to four SRS resources. The NW measures the UL channel based on the received SRS, selects the preferred SRS resource(s), and indicates the selection via the SRS resource Indicator (SRI) field in the DCI. The UE uses this information to precode PUSCH with a transmission rank that equals the number of indicated SRS resources (and, hence, the number of SRS ports).

The size of the SRI field in the DCI format scheduling the PUSCH is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits .$$

Here, N_{SRS} is the number of SRS resources and Lₘₐₓ is the maximum number of layers.

### DMRS for PUSCH

DMRS for PUSCH is an UL RS (that consists of a pseudo-random Quadrature phase shift keying (QPSK) sequence for CP-OFDM or a low-Peak-to-Average Power Ratio (PAPR) sequence for DFT-S-OFDM) that is used for demodulating PUSCH such that the receiver (i.e., the gNB) can handle time-varying and/or frequency-selective channels. DMRS is confined to the scheduled PUSCH time-and-frequency-domain allocation.

The mapping of DMRS to Resource Elements (REs) is configurable in both frequency and time domain. In the frequency domain, there are two mapping types: type 1 (comb based) or type 2 (non-comb based). In the time-domain, DMRS can be either single symbol or double symbol, where the latter means that DMRS is mapped in pairs of two adjacent symbols. Furthermore, a UE can be configured with one, two, three, or four single-symbol DMRS, or one or two double-symbol DMRS. In low-Doppler scenarios, one DMRS symbol may be sufficient whereas in high-Doppler scenarios, additional DMRS symbols are required.

If transform precoding is disabled (i.e., if the waveform is CP-OFDM), DMRS for PUSCH can be additionally and optionally configured with respect to scrambling ID 0 and 1, configured by RRC parameters scramblingID0 and scramblingID1, respectively, which are used for generating the pseudo-random DMRS sequence.

If transform precoding is enabled (i.e., if the waveform is DFT-S-OFDM), DMRS group hopping or sequence hopping can be configured by the higher-layer parameters sequenceGroupHopping and sequenceHopping. If π/2-BPSK modulation is not used for PUSCH, the higher-layer parameter nPUSCH-Identity determines the low-PAPR sequence.

In NR Rel-16, to reduce PAPR for DMRS for CP-OFDM combined with fully coherent precoding, the higher-layer parameter dmrs-Uplink-r16 can be enabled. Doing so makes the DMRS sequence depend on the CDM group, which can be shown to reduce PAPR. If this field is not present, the same DMRS sequence is used over all CDM groups. Furthermore, to reduce PAPR for DMRS for DFT-S-OFDM when π/2-BPSK is used together with spectrum shaping, two different scrambling seeds can be configured via the higher-layer parameter dmrs-UplinkTransformPrecoding-r16. If this field is not present, the cell ID is used as scrambling seed.

### DMRS for PUSCH Port Mapping

DMRS ports are mapped to resource elements within one Code Division Multiplexing (CDM) group. DMRS ports that belong to the same CDM group are separated by a length-2 Frequency Domain (FD)-Orthogonal Cover Code (OCC) (and a length-2 Time Domain (TD)-OCC, for double-symbol DMRS). Specifically, the DMRS sequence is mapped to the following subcarriers (for DFT-S-OFDM, only DMRS type 1 is supported):

$$k = \{ \text{} \begin{matrix}4 n + 2 {k}^{′} + Δ , & for type 1 , \\ 6 n + {k}^{′} + Δ , & for type 2.\end{matrix} \text{}$$

Here, k is the subcarrier index (which starts/ends at the first/last subcarrier within the scheduled PUSCH bandwidth), n∈{0, 1, 2, . . . }, k′∈{0, 1}, and Δ is an offset that depends on the CDM group.

From the transmitter's perspective, the number of DMRS ports used for PUSCH transmission coincides with the rank, i.e., one DMRS port per transmitted layer.

The DMRS port mapping is signaled to the UE from the gNB via the field “Antenna ports” in the DCI scheduling the PUSCH. REs, which are associated with a CDM group, that are not used for DMRS can be used for PUSCH. After layer mapping, the DMRS and the associated PUSCH are mapped to physical antennas through PUSCH precoding.

### Relevant Ongoing Standardization of STxMP in NR Rel-18

In NR-Rel 18, it has been agreed to specify support for UL transmissions from up to two simultaneously transmitting UE panels to up to two Transmit Receive Points (TRPs).

It has been agreed that Spatial Division Multiplexing (SDM), for which different layers of a same transmission are transmitted from different panels and Single Frequency Network (SFN), for which same layers are transmitted from different panels will be supported for single-DCI Simultaneous Transmission from Multiple Panels (STxMP); a single DCI can schedule simultaneous transmission from both UE panels to both TRPs.

It has been further agreed that multi-DCI based PUSCH+PUSCH scheduling will be supported for multi-DCI STxMP (different DCIs from different TRPs can schedule simultaneous transmission to different TRPs). At least DG-PUSCH+DG-PUSCH and CG-PUSCH+CG-PUSCH will be supported.

For single-DCI STxMP, it has been agreed that two SRS resource sets (one per panel) will be configured. Furthermore, it has been agreed that there will be an SRI and/or TPMI field per SRS resource set (depending on whether CB-based PUSCH or NCB-based PUSCH is configured). This holds for both SDM and SFN. For SFN, the transmission rank is conveyed only by the first SRI/TPMI field.

During the RAN1 #111 meeting, it was agreed that for an SDM transmission of L=L₁+L₂ layers, the first L₁ DMRS ports in a single “Antenna ports” field in the DCI scheduling the PUSCH are associated with a first SRS resource set (or, equivalently, with a first SRI or TPMI field) and that the remaining L₂ DMRS are associated with a second SRS resource set (or, equivalently, with a second SRI or TPMI field).

### SUMMARY

There currently exist certain challenge(s). To improve UL coverage for cell-edge UEs, it is important that DFT-S-OFDM is supported for UEs configured with STxMP. However, how to support DFT-S-OFDM for different STxMP configurations has not yet been agreed (or even discussed) in 3GPP.

For multi-DCI STxMP scheduled by a DG, DFT-S-OFDM can be supported by configuring transform precoding for the PUSCH associated with the first and second TRP, respectively. Furthermore, the corresponding DMRS configuration can be such that orthogonal DMRS ports are used for the first and second TRPs, which is essential in scenarios where cross-panel interference between DMRS cannot be neglected.

For single-DCI SFN STxMP (for which the same layers are transmitted from different panels), DFT-S-OFDM can be supported by configuring transform precoding for a single-layer PUSCH transmission (recall that only single-layer PUSCH is supported for DFT-S-OFDM in legacy NR). In this case, a single DMRS port, associated with a single layer, will be transmitted to both TRPs. Since there is only a single DMRS port, there is no cross-panel interference.

However, for single-DCI SDM STxMP (for which different layers of a same transmission are transmitted from different panels), the minimum number of layers is two (for the case when both SRS resource sets are indicated in the DCI scheduling the PUSCH). Hence, since only single-layer DFT-S-OFDM is supported in legacy NR, it is unclear how DFT-S-OFDM can be supported for single-DCI SDM STxMP.

Certain aspects of the disclosure and their embodiments may provide solutions to these or other challenges.

For example, support for rank-2 (or higher) DFT-S-OFDM for SDM STxMP (i.e., for a UE scheduled to simultaneously transmit PUSCH over two SRS resource sets or more) is enabled through the following: using a new “Antenna ports” table and corresponding signaling to support two DMRS ports or more for DFT-S-OFDM.

For example, for DG-PUSCH/CG PUSCH type 2 configured with transform precoding, the DCI scheduling/activating the PUSCH can indicate a first DMRS port associated with a first DFT-S-OFDM layer (or first SRS resource set) and a second DMRS port associated with a second DFT-S-OFDM layer (or second SRS resource set).

Also, for CG-PUSCH type 1, the RRC configuration of PUSCH can indicate a first DMRS port associated with a first DFT-S-OFDM layer (or first SRS resource set) and a second DMRS port associated with a second DFT-S-OFDM layer (or second SRS resource set).

In this disclosure, there are provided methods in a UE and in a network node for handling DFT-S-OFDM and SDM STxMP. For example, a method in a UE, equipped with a plurality of panels, may comprise: receiving, from a network node, a configuration of a plurality of SRS resource sets for PUSCH transmissions with multiple layers using DFT-S-OFDM; receiving an indication from the network node, the indication comprising one or more DMRS ports mapped to the plurality of SRS resource sets; and sending simultaneously a PUSCH transmission based on the indication, from each panel of the plurality of panels, wherein each panel is associated with a SRS resource set of the plurality of SRS resource sets.

For example, a method in a network node may comprise: sending, to the UE, a configuration of a plurality of SRS resource sets for PUSCH transmissions with multiple layers using DFT-S-OFDM; sending an indication to the UE (equipped with a plurality of panels), the indication comprising one or more DMRS ports mapped to the plurality of SRS resource sets; and receiving a plurality of PUSCH transmissions based on the indication, from each panel of the plurality of panels, wherein each panel is associated with a SRS resource set of the plurality of SRS resource sets.

There are also provided a UE, a network node and a non-transitory medium to perform the above methods.

Certain embodiments may provide one or more of the following technical advantage(s).

The proposed embodiments enable rank-2 (or higher) DFT-S-OFDM transmission with orthogonal DMRS ports for SDM STxMP, which can increase UL throughput in coverage-limited scenarios (legacy NR supports only rank-1 DFT-S-OFDM).

### BRIEF DESCRIPTION OF THE DRAWINGS

Exemplary embodiments will be described in more detail with reference to the following figures, in which:

FIG. 1 illustrates a schematic example of two types of DRMS: Type 1 (top part of the figure) and type 2 (bottom part of the figure) single/double-symbol DMRS.

FIG. 2 illustrates a schematic example of a single-symbol DMRS with two additional single-symbol DMRS (left part of the figure) and double-symbol DMRS with one additional double-symbol DMRS (right part of the figure). The figure is valid for DMRS type 1 and front-loaded PUSCH (i.e., PUSCH mapping type A) of duration 14 symbols.

FIG. 3 illustrates an example of a signaling diagram for communications between a UE and a network node, according to an embodiment.

FIG. 4 illustrates an example of a flow chart of a method in a UE, according to an embodiment.

FIG. 5 illustrates an example of a flow chart of a method in a network node, according to an embodiment.

FIG. 6 shows an example of a communication system, according to an embodiment.

FIG. 7 shows a schematic diagram of a UE, according to an embodiment.

FIG. 8 shows a schematic diagram of a network node, according to an embodiment.

FIG. 9 illustrates a block diagram of a host.

FIG. 10 illustrates a block diagram illustrating a virtualization environment.

FIG. 11 shows a communication diagram of a host.

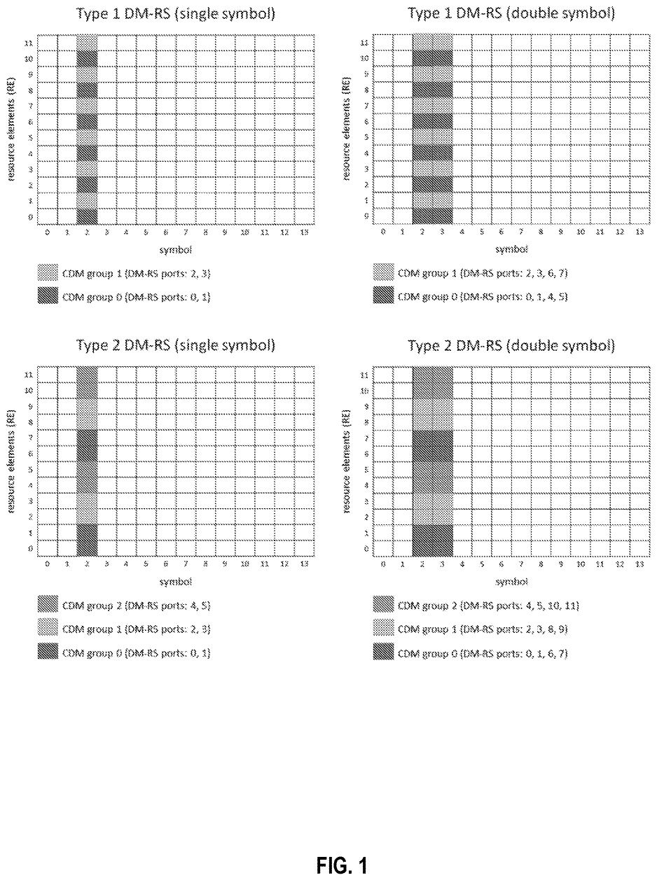

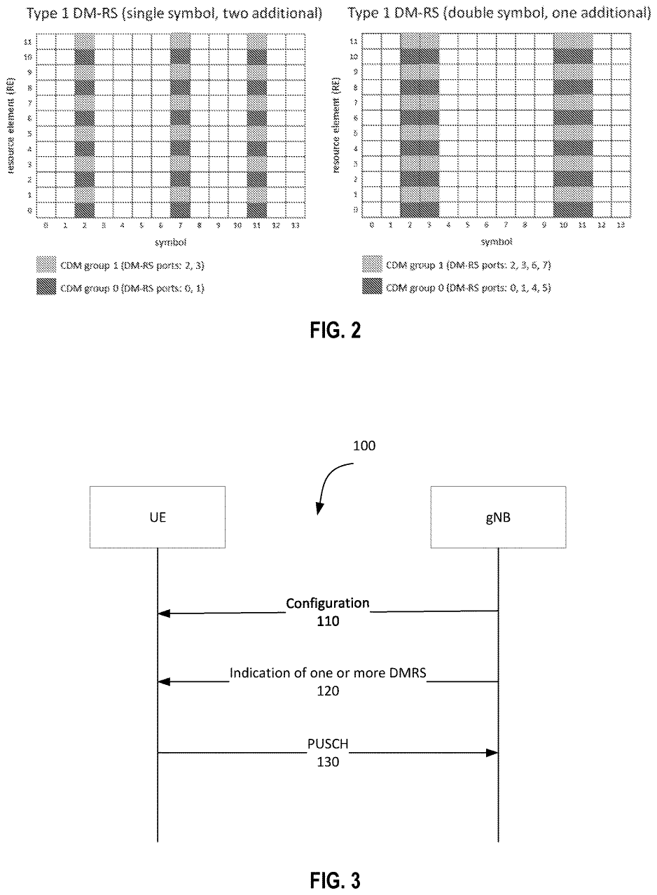

### DETAILED DESCRIPTION

Some of the embodiments contemplated herein will now be described more fully with reference to the accompanying drawings. Embodiments are provided by way of example to convey the scope of the subject matter to those skilled in the art.

FIG. 3 illustrates an example of a signaling diagram 100 between a UE and a gNB for DFT-S-OFDM transmissions with orthogonal DMRS ports for SDM STxMP.

The UE is configured/equipped with a plurality of panels, from which simultaneous UL transmissions can be sent out. For example, the UE supports STxMP and may be configured with a plurality of SRS resource sets. The UE may receive a DCI for scheduling a simultaneous transmission from the plurality of panels. The UE may also support DFT-S-OFDM when transmitting the UL transmissions, when configured with STxMP. The support of DFT-S-OFDM is achieved by configuring transform precoding for the PUSCH transmissions, for example.

In step 110, the UE may receive a configuration of a plurality of SRS resource sets, from the gNB. Each panel may use (or may be configured with) one SRS resource set.

In step 120, the UE receives an indication (via e.g. DCI or RRC) from the network node, the indication comprising one or more DMRS ports mapped to the plurality of SRS resource sets. For example, in case of a rank 2 transmission, the indication comprises a first DMRS port associated with a first DFT-S-OFDM layer (first SRS resource set) and second DMRS port associated with a second DFT-S-OFDM layer (second SRS resource set). As an option, the first DMRS port can be associated with both SRS resource sets. In this case, the second DMRS port is not present. As a note, a DMRS port may be associated (or corresponds to) with a PUSCH layer.

In step 130, the UE sends simultaneously a UL (e.g. PUSCH) transmission according to the indication, from each panel of the plurality of panels.

In a general example, the indication indicates x DMRS ports for a rank x (or for x layers). As one example, a same DMRS port can be used/indicated for different layers/SRS resource sets.

Details of some examples of the indication are provided below. For example, the indication can be based on a table. In this case, new tables of “antenna ports” can be generated or existing tables can be reused.

New “Antenna Ports” Table(s) for PUSCH Configured with Transform Precoding

In what follows, it is assumed that the rank used to determine the new “Antenna ports” table for DFT-S-OFDM is 2. This can occur only if there are two SRS resource sets configured with the same usage ‘codebook’ or ‘nonCodebook’ and if SDM STxMP is configured (via higher-layer signaling) when transform precoding is enabled for PUSCH (e.g., in PUSCH-Config IE for DG-PUSCH or in ConfiguredGrantConfig IE for CG-PUSCH). However, the embodiments can apply to any ranks higher than 2.

Different sequences are used for DMRS for DFT-S-OFDM depending on whether π/2-Binary Phase Shift Keying (BPSK) modulation is configured or not. In the following, we treat separately the case of non-π/2-BPSK modulation and π/2-BPSK modulation.

### Low-PAPR Sequence for Non-π/2-BPSK Modulation

In an embodiment, a new “Antenna ports” table is introduced in the NR specification to enable signaling of a plurality (two or more) of DMRS ports for DFT-S-OFDM configured with non-π/2-BPSK modulation.

In one example of this embodiment, for non-π/2-BPSK modulation, the table shown in Table 1 supports rank-2 DFT-S-OFDM. This table allows using the same CDM group over both panels (SRS resource sets) via value 0-1 or using different CDM groups over both panels (SRS resource sets) via value 2-3, which is in line with RAN1 #111 agreements. Ports in the same CDM group are distinguished by using different FD-OCCs, for example.

TABLE 1
(Table 7.3.1.1.2-X in 3GPP TS 38.212) Antenna port(s), transform
precoder is enabled and two SRS resource sets are configured in,
e.g., srs-ResourceSetToAddModList for DCI Format 0_1 (or srs-
ResourceSetToAddModListDCI-0-2 for DCI Format 0_2) with higher
layer parameter usage in SRS-ResourceSet set to ‘codebook’ or
‘noncodebook’, dmrs-Type = 1, maxLength = 1, rank = 1,
except that dmrs-UplinkTransformPrecoding and tp-pi2BPSK are
both configured and π/2-BPSK modulation is used

| | Number of DMRS CDM | DMRS |
|---|---|---|
| Value | group(s) without data | port(s) |
| 0 | 2 | 0, 1 |
| 1 | 2 | 2, 3 |
| 2 | 2 | 0, 2 |
| 3 | 2 | 1, 3 |

For example, in step 120, the indication may comprise the value of 0, 1, 2, or 3. If the indication has a value of 0, the UE looks up at the table 1, to determine that 2 DMRS ports (e.g. 0 and 1) are identified/indicated for the SRS resource sets. The UE can then determine that one SRS resource set is mapped to DMRS port 0 and one SRS resource set is mapped to DMRS port 1. In case of a higher rank, e.g. 4, the column for DMRS ports of table 1 can comprise/indicate 4 values, each value indicating a DMRS port that can be associated with a SRS resource set. The UE may associate a DMRS port with an SRS resource set in different ways. It could be according to a UE implementation or other ways. For example, the UE can associate the first DMRS port in the table with a first SRS resource set and the second DRMS port with a second SRS resource set and so on.

In an alternate embodiment, the existing (i.e., in legacy NR specification) “Antenna ports” tables can be repurposed/reinterpreted to support DFT-S-OFDM.

In one example of this alternate embodiment, for non-π/2-BPSK modulation, Table 2 or Table 7.3.1.1.2-9 in 3GPP TS 38.212 (which determines corresponding DMRS ports for rank-2 CP-OFDM for CP-OFDM PUSCH waveform) is used also for determining DMRS ports for DFT-S-OFDM.

In another example, for DFT-S-OFDM the number of DMRS CDM groups without data is 2 irrespectively of the indicated value according to the table (i.e., value 0 is allowed). In another example of this alternate embodiment, the UE cannot be configured with less than two CDM groups without data (i.e., value 0) for DFT-S-OFDM. A drawback with repurposing the existing table is that DMRS ports 1 and 3 cannot be indicated, which prevents MU-MIMO multiplexing of STxMP UEs using different CDM groups for each panel. To address this drawback, in another example of this alternate embodiment, one of the reserved codepoints (e.g., value 4) is repurposed to indicate DMRS ports 1 and 3 with 2 DMRS CDM groups without data.

TABLE 2
(Modified Table 7.3.1.1.2-9 in 3GPP TS 38.212) Antenna
ports if transform precoder is disabled, or if transform
precoder is enabled and two SRS resource sets are
configured in, e.g., srs-ResourceSetToAddModList for
DCI Format 0_1 (or srs-ResourceSetToAddModListDCI-0-2
for DCI Format 0_2) with higher layer parameter usage
in SRS-ResourceSet set to ‘codebook’ or ‘noncodebook’,
dmrs-Type = 1, maxLength = 1, rank = 2.

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

### Pseudo-Random Sequence for π/2-BPSK Modulation

In one embodiment, a new “Antenna ports” table is introduced in NR specification to enable signaling of a plurality (two, or more) of DMRS ports for DFT-S-OFDM configured with π/2-BPSK modulation.

In one example of this embodiment, for π/2-BPSK modulation, the table shown in Table 3 is introduced to support rank-2 DFT-S-OFDM.

TABLE 3
(Table 7.3.1.1.2-9 in 3GPP TS 38.212) Antenna port(s),
transform precoder is enabled and two SRS resource
sets are configured in, e.g., srs-ResourceSetToAddModList
for DCI Format 0_1 (or srs-ResourceSetToAddModListDCI-
0-2 for DCI Format 0_2) with higher layer parameter
usage in SRS-ResourceSet set to ‘codebook’ or ‘noncodebook’,
dmrs-UplinkTransformPrecoding and tp-pi2BPSK are both
configured, π/2-BPSK modulation is used, dmrs-Type = 1,
maxLength = 1, rank = 2.

| | Number of DMRS CDM | DMRS |
|---|---|---|
| Value | group(s) without data | port(s) |
| 0 | 2 | 0, n_{SCID} = 0 & 0, n_{SCID} = 1 |
| 1 | 2 | 1, n_{SCID} = 0 & 1, n_{SCID} = 1 |
| 2 | 2 | 0, n_{SCID} = 0 & 1, n_{SCID} = 0 |
| 3 | 2 | 0, n_{SCID} = 1 & 1, n_{SCID} = 1 |

Here, n_{SCID} is a parameter that determines the pseudo-random sequence for DMRS for DFT-S-OFDM configured with π/2-BPSK modulation.

The above table 3 allows using the same CDM group over both panels (SRS resource sets) via value 0-1 or using different CDM groups over both panels (SRS resource sets) via value 2-3, which is in line with RAN1 #111 agreements. Ports in the same CDM group are distinguished by using different sequences.

For example, in step 120, the indication may comprise the value 0, 1, 2, or 3. If the indication has a value of 0, the UE looks up at the table 3, to determine that 2 DMRS ports are identified/indicated for the SRS resource sets. The UE can then determine that one SRS resource set is mapped to DMRS port 0 and one SRS resource set is mapped to DRMS port 1. In case of a higher rank, e.g. 4, the column for DMRS ports of table 3 can comprise/indicate 4 values, each value indicating a DMRS port that can be associated with a SRS resource set. The UE may associate a DMRS port with a SRS resource set in different ways. It could be according to a UE implementation or other ways. For example, the UE can associate the first DMRS port in the table with a first SRS resource set and the second DRMS port with a second SRS resource set and so on.

Note that in this case there exists no legacy tables for rank>1 DFT-S-OFDM configured with π/2-BPSK modulation. Hence, it is not possible to repurpose existing tables in this case.

### Extension to Double-Symbol DMRS

The above examples are valid for rank-2 DFT-S-OFDM with single-symbol DMRS (maxLength=1). However, it should be possible to indicate 2 DMRS ports for rank-2 DFT-S-OFDM with double-symbol DMRS (maxLength=2) as well.

Therefore, in one embodiment, new tables are introduced or existing tables are repurposed for double-symbol DMRS as well. For example, the new tables can be introduced and the existing tables are repurposed as shown below.

In one embodiment, the antenna port table(s) for CP-OFDM with rank >1 are used also for transform precoder, but only those entries with “Number of DMRS CDM group(s) without data” equal to the total number of CDM groups for the corresponding DMRS Type can be indicated.

In the example of Table 4, the entry with index 0 for which “Number of DMRS CDM group(s) without data” is 1 cannot be used with transform precoding. In this case, only a subset of an existing table can be reused for double-symbol DMRS for indicating one or more DMRS mapped to a plurality of SRS resource sets.

TABLE 4
(Table 7.3.1.1.2-13 in 3GPP TS 38.212): Antenna port(s), if transform
precoder is disabled, or if transform precoder is enabled and two SRS
resource sets are configured in, e.g., srs-ResourceSetToAddModList
for DCI Format 0 1 (or srs-ResourceSetToAddModListDCI-0-2 for DCI
Format 0_2) with higher layer parameter usage in SRS-ResourceSet set to
‘codebook’ or ‘noncodebook’, dmrs-Type = 1, maxLength = 2, rank = 2

| | Number of DMRS CDM | DMRS | Number of |
|---|---|---|---|
| Value | group(s) without data | port(s) | front-load symbols |
| [symbol] | [symbol] | [symbol] | [symbol] |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

In another embodiment, new tables are introduced for double symbol DMRS when transform precoding is enabled. In the following, we provide two examples of new tables, for the case when π/2-BPSK is not configured and configured, respectively.

TABLE 5
(Table 7.3.1.1.2-X in 3GPP TS 38.212): Antenna port(s),
transform precoder is enabled (except that dmrs-
UplinkTransformPrecoding and tp-pi2BPSK are both
configured and π/2-BPSK modulation is used) and
two SRS resource sets are configured in, e.g., srs-
ResourceSetToAddModList for DCI Format 0_1 (or
srs-ResourceSetToAddModListDCI-0-2 for DCI
Format 0_2) with higher layer parameter usage in
SRS-ResourceSet set to ‘codebook’ or ‘noncodebook’,
dmrs-Type = 1, maxLength = 2, rank = 2

| | Number of DMRS CDM | DMRS | Number of front- |
|---|---|---|---|
| Value | group(s) without data | port(s) | load symbols |
| 0 | 2 | 0, 2 | 1 |
| 1 | 2 | 1, 3 | 1 |
| 2 | 2 | 0, 1 | 1 |
| 3 | 2 | 2, 3 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10 | 2 | 1, 5 | 2 |
| 11 | 2 | 3, 7 | 2 |
| 12-15 | Reserved | Reserved | Reserved |

TABLE 6
(Table 7.3.1.1.2-X in 3GPP TS 38.212) Antenna port(s),
transform precoder is enabled and two SRS resource
sets are configured in, e.g., srs-ResourceSetToAddModList
for DCI Format 0_1 (or srs-ResourceSetToAddModListDCI-
0-2 for DCI Format 0_2) with higher layer parameter
usage in SRS-ResourceSet set to ‘codebook’ or ‘noncodebook’,
dmrs-UplinkTransformPrecoding and tp-pi2BPSK are both
configured, π/2-BPSK modulation is used, dmrs-Type = 1,
maxLength = 2, rank = 2.

| | Number of DMRS | | Number of |
|---|---|---|---|
| | CDM group(s) | DMRS | front-load |
| Value | without data | port(s) | symbols |
| 0 | 2 | 0, n_{SCID} = 0 & 0, n_{SCID} = 1 | 1 |
| 1 | 2 | 0, n_{SCID} = 0 & 2, n_{SCID} = 0 | 1 |
| 2 | 2 | 2, n_{SCID} = 0 & 2, n_{SCID} = 1 | 1 |
| 3 | 2 | 0, n_{SCID} = 1 & 2, n_{SCID} = 1 | 1 |
| 4 | 2 | 0, n_{SCID} = 0 & 0, n_{SCID} = 1 | 2 |
| 5 | 2 | 0, n_{SCID} = 0 & 2, n_{SCID} = 0 | 2 |
| 6 | 2 | 2, n_{SCID} = 0 & 2, n_{SCID} = 1 | 2 |
| 7 | 2 | 0, n_{SCID} = 1 & 2, n_{SCID} = 1 | 2 |
| 8 | 2 | 0, n_{SCID} = 0 & 4, n_{SCID} = 0 | 2 |
| 9 | 2 | 0, n_{SCID} = 1 & 4, n_{SCID} = 1 | 2 |
| 10 | 2 | 2, n_{SCID} = 0 & 6, n_{SCID} = 0 | 2 |
| 11 | 2 | 2, n_{SCID} = 1 & 6, n_{SCID} = 1 | 2 |
| 12-15 | Reserved | Reserved | Reserved |

### RRC Signaling of DMRS Ports for Rank-2 CG-PUSCH Type 1

For PUSCH scheduled by CG type 1, the DMRS port indication is via RRC signaling. In one embodiment, if transform precoding and two SRS resource sets are configured for CG-PUSCH and if STxMP operation is configured (e.g., if the UE has indicated capability for STxMP), the number of DMRS ports for the CG-PUSCH is 2. Furthermore, up to 2 DMRS ports according to the above tables can be configured via higher-layer signaling (i.e., RRC-configured).

### UE Capability Signaling

Before being configured with rank-2 (or higher) DFT-S-OFDM for SDM STxMP, the UE needs to indicate that it supports this feature. This can be done through UE capability, for example. In the following, a UE that supports SDM STxMP is referred to as a STxMP UE. In one embodiment, a STxMP UE reports a separate value for its maximum supported rank for DFT-s-OFDM: maxRank-transformPrecoding. In another embodiment, if the STxMP UE reports support for maxRank, then support for rank-2 DFT-S-OFDM for STxMP SDM is implied (if rank 2 is the maximum supported rank; the maximum rank can be changed).

In one example, the same DMRS port can be mapped to both of the SRS resource sets.

In this case, no new “antenna ports” tables are introduced and when STxMP SDM is configured for DFT-S-OFDM, the same DMRS port is mapped to both SRS resource sets.

In this case, when there are two SRS resource sets configured with the same usage ‘codebook’ or ‘nonCodebook’ and transform precoding is enabled, the UE shall assume that the rank is 1 when determining DMRS antenna-port table. This implies that the first of the RAN1 #111 agreements does not apply when STxMP SDM is configured for DFT-S-OFDM.

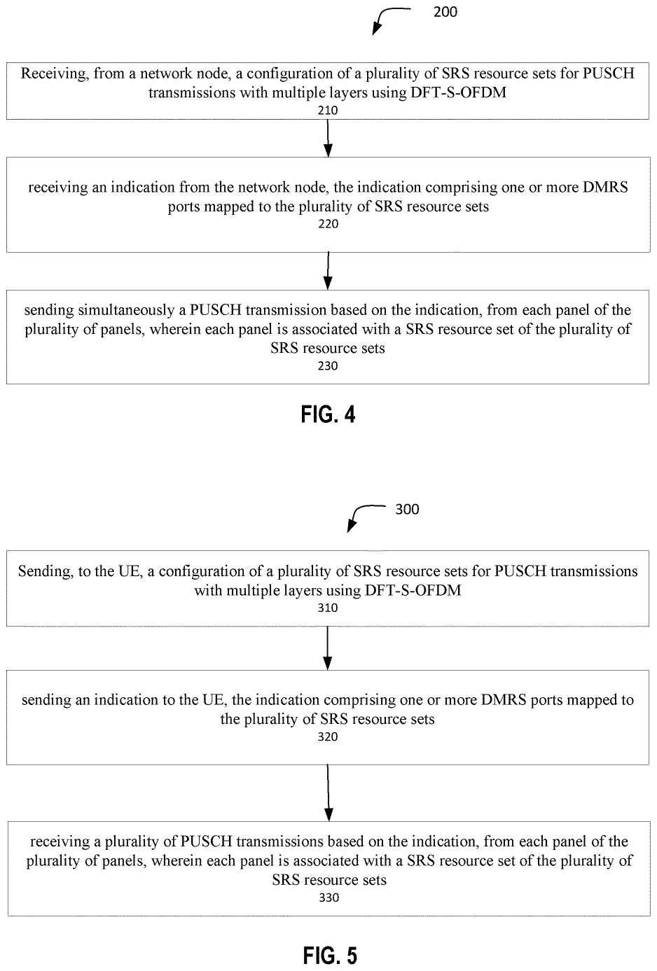

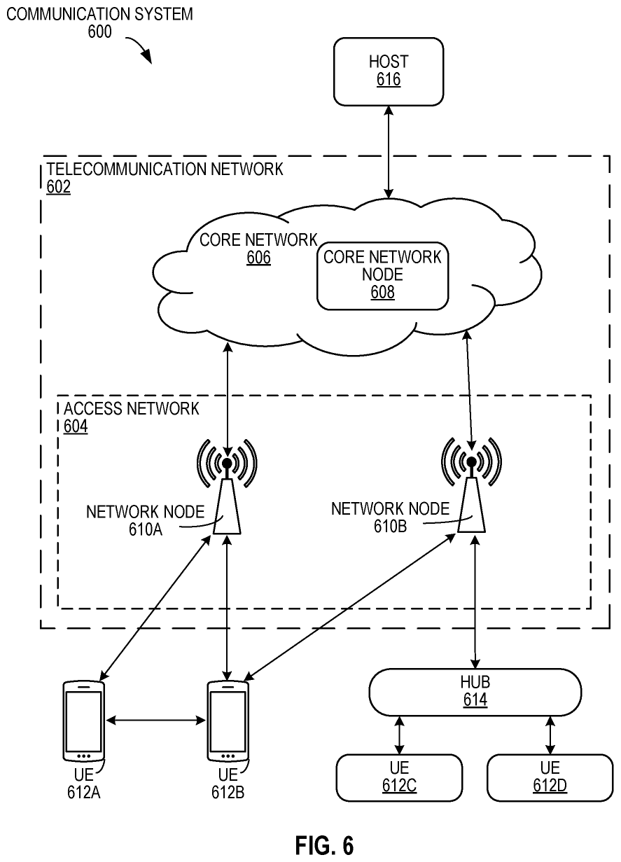

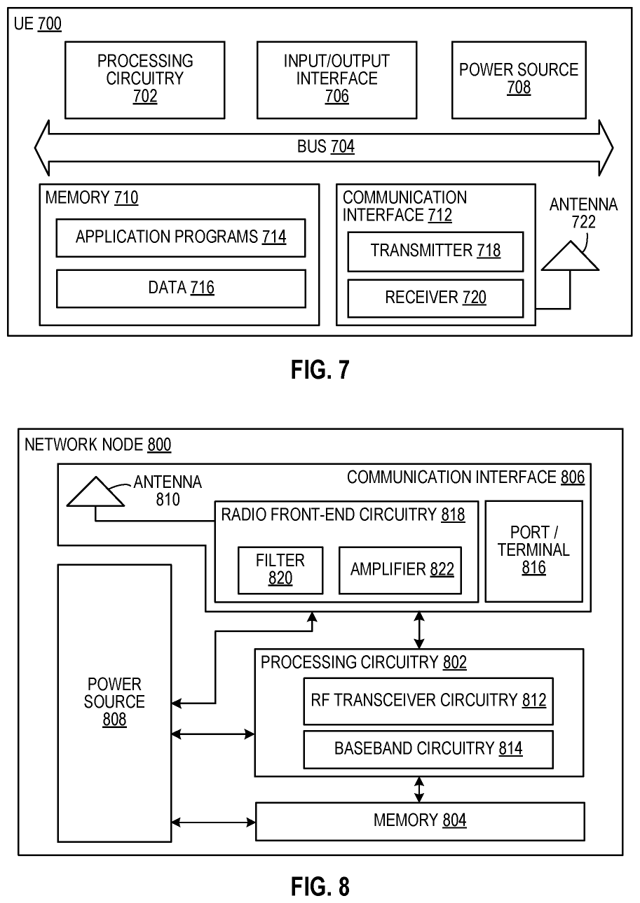

Now turning to FIG. 4, an example of a flow chart of a method 200 in a UE will be described. The UE is configured with DFT-S-OFDM for STxMP operation. As such, the UE is configured/equipped with a plurality of panels. The UE may be the UE 612 of FIG. 6 or UE 700 of FIG. 7. Method 200 comprises:
Step 210: receiving, from a network node, a configuration of a plurality of SRS resource sets for PUSCH transmissions with multiple layers using DFT-S-OFDM;
Step 220: receiving an indication from the network node, the indication comprising one or more DMRS ports mapped to the plurality of SRS resource sets; and
Step 230: sending simultaneously a PUSCH transmission based on the indication, from each panel of the plurality of panels, wherein each panel is associated with a SRS resource set of the plurality of SRS resource sets.

In some examples, the multiple layers can be associated with the plurality of SRS resource sets and one layer of the multiple layers is associated with each SRS resource set. In some examples, the UE may send a capability signaling to the network node, the capability signaling comprising an indication of support for SDM STxMP. In some examples, the capability signaling may comprise a maximum supported rank. In some examples, the indication may be based on a table, that provides the mapping of the one or more DMRS ports to the plurality of SRS resource sets. Alternatively, the indication may provide the identities of the one or more DMRS to be mapped to the plurality of SRS resource sets. In some examples, the table can be a new table indicating antenna ports, generated for DFT-S-OFDM for STxMP operation. In some examples, the table can be an existing table (or a subset of an existing table), used for CP-OFDM, reused for DFT-S-OFDM for STxMP operation. As such, the table is based on the table for DFT-S-OFDM. In some examples, the UL/PUSCH transmission can use a non-π/2-BPSK modulation or use a π/2-BPSK modulation. In some examples, the indication can be received in DCI or RRC signaling. In some examples, a same CDM group can be used for all the DMRS ports or SRS resource sets. In some examples, different CDM groups can be used for all the DMRS ports or SRS resource sets. In some examples, a DMRS is a single-symbol DMRS or a double-symbol DMRS. In some examples, the plurality of SRS resource sets is two and wherein a same DMRS port is mapped to both of the SRS resource sets.

Turning to FIG. 5, an exemplary flow chart of a method 300, in a network node in communication with a UE, configured with DFT-S-OFDM for STxMP operation, will be described. The UE may comprise (or equipped with) a plurality of panels, from which simultaneous transmissions can be sent out. The network node may be the network node 610 of FIG. 6 or 800 of FIG. 8. Method 300 comprises:
Step 310: sending, to the UE, a configuration of a plurality of SRS resource sets for PUSCH transmissions with multiple layers using DFT-S-OFDM;
Step 320: sending an indication to the UE, the indication comprising one or more DMRS ports mapped to the plurality of SRS resource sets; and
Step 330: receiving a plurality of PUSCH transmissions based on the indication, from each panel of the plurality of panels, wherein each panel is associated with a SRS resource set of the plurality of SRS resource sets.

In some examples, the multiple layers can be associated with the plurality of SRS resource sets and one layer of the multiple layers can be associated with each SRS resource set. In some examples, the network node may receive a capability signaling from the UE, the capability signaling comprising an indication of support for SDM STxMP. In some examples, the capability signaling can comprise a maximum supported rank. In some examples, the indication is based on a table, that provides the mapping of the one or more DMRS ports to the plurality of SRS resource sets. Alternatively, the table may provide the identities of the one or more DMRS for mapping the plurality of SRS resource sets. In some examples, the table is a new table indicating antenna ports, generated for DFT-S-OFDM for STxMP operation. In some examples, the table is an existing table (or a subset of an existing table), used for CP-OFDM, reused for DFT-S-OFDM for STxMP operation. As such, the table is based on a table for CP-OFDM. In some examples, the UL/PUSCH transmission can use a non-π/2-BPSK modulation or use a π/2-BPSK modulation. In some examples, the indication can be sent in DCI or RRC. For example, the DCI or RRC indicates a first DMRS port associated with a first SRS resource set and a second DMRS associated with a second SRS resource set. In some examples, a same CDM group can be used for all the DMRS ports or SRS resource sets. In some examples, different CDM groups can be used for all the DMRS ports or SRS resource sets. In some examples, a DMRS is a single-symbol DMRS or a double-symbol DMRS.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of UE, such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs). Further, the processing circuitry 702 is configured to perform any steps of method 200 of FIG. 4. The UE may also comprise one or more panels, for simultaneous UL transmissions.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, and the like. The presence-sensitive display may include a capacitive or resistive touch sensor to sense input from a user. A sensor may be, for instance, an accelerometer, a gyroscope, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units. Further, the processing circuitry 802 may be configured to perform any steps of method 300 of FIG. 5.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

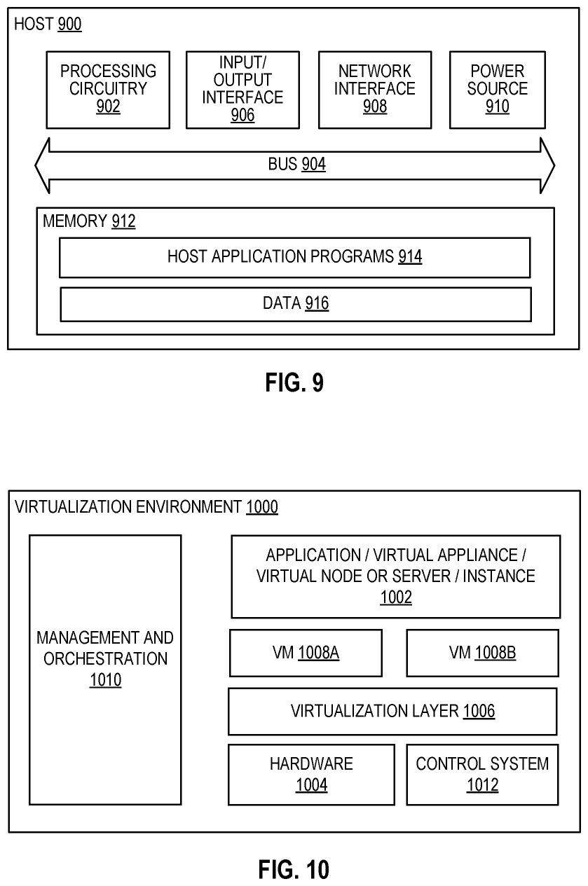

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

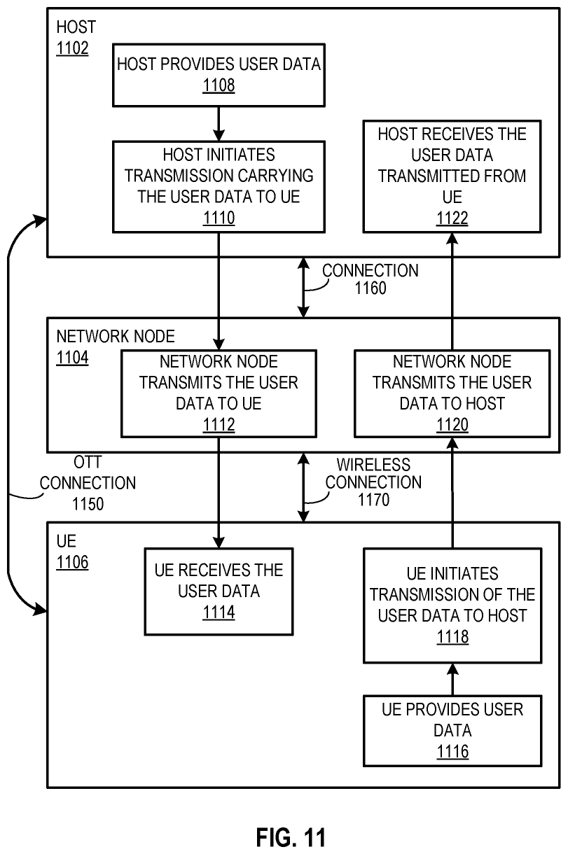

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption and thereby provide benefits such as e.g., reduced user waiting time, relaxed restriction on file size, improved content resolution, better responsiveness, extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

1. A method performed by a user equipment (UE), equipped with a plurality of panels, the method comprising:
receiving, from a network node, a configuration of a plurality of sounding reference signal (SRS) resource sets for physical uplink shared channel (PUSCH) transmissions with multiple layers using Discrete Fourier Transform (DFT)-Spread (S)-Orthogonal Frequency Division Multiplexing (OFDM);
receiving an indication from the network node, the indication comprising one or more Demodulation Reference Signal (DMRS) ports mapped to the plurality of SRS resource sets; and
sending simultaneously a PUSCH transmission based on the indication, from each panel of the plurality of panels, wherein each panel is associated with a SRS resource set of the plurality of SRS resource sets.

2. The method of claim 1, wherein the multiple layers are associated with the plurality of SRS resource sets and one layer of the multiple layers is associated with each SRS resource set.

3. The method of claim 1, further comprising sending a capability signaling to the network node, the capability signaling comprising an indication of support for Spatial Division Multiplexing (SDM) Simultaneous Transmission from Multiple Panels (STxMP).

4. The method of claim 3, wherein the capability signaling comprises a maximum supported rank.

5. The method of claim 1, wherein the indication is based on a table, that provides the mapping of the one or more DMRS ports to the plurality of SRS resource sets.

6. The method of claim 5, wherein the table is a new table indicating antenna ports, generated for DFT-S-OFDM for STxMP operation.

7. The method of claim 5, wherein the table is based on a table used for Cyclic Prefix (CP)-OFDM.

8. The method of claim 1, wherein the PUSCH transmission uses non-π/2-BPSK modulation or π/2-BPSK modulation.

9. (canceled)

10. The method of claim 1, wherein the indication is received in Downlink Control Information (DCI) or Radio Resource Control (RRC).

11. The method of claim 10, wherein the DCI or RRC indicates a first DMRS port associated with a first SRS resource set and a second DMRS associated with a second SRS resource set.

12. The method of claim 1, wherein a same Code Division Multiplexing (CDM) group is used for all the DMRS ports or SRS resource sets or different CDM groups are used for all the DMRS ports or SRS resource sets.

13. (canceled)

14. (canceled)

15. (canceled)

16. A method performed by a network node in communication with a user equipment (UE), equipped with a plurality of panels, the method comprising:
sending, to the UE, a configuration of a plurality of sounding reference signal (SRS) resource sets for physical uplink shared channel (PUSCH) transmissions with multiple layers using Discrete Fourier Transform (DFT)-Spread (S)-Orthogonal Frequency Division Multiplexing (OFDM);
sending an indication to the UE, the indication comprising one or more Demodulation Reference Signal (DMRS) ports mapped to the plurality of SRS resource sets; and
receiving a plurality of PUSCH transmissions based on the indication, from each panel of the plurality of panels, wherein each panel is associated with a SRS resource set of the plurality of SRS resource sets.

17. (canceled)

18. The method of claim 16, further comprising receiving a capability signaling from the UE, the capability signaling comprising an indication of support for Spatial Division Multiplexing (SDM) Simultaneous Transmission from Multiple Panels (STxMP).

19. (canceled)

20. The method of claim 16, wherein the indication is based on a table, that provides the mapping of the one or more DMRS ports to the plurality of SRS resource sets.

21. The method of claim 20, wherein the table is a new table indicating antenna ports, generated for DFT-S-OFDM for STxMP operation.

22. The method of claim 20, wherein the table is based on a table, used for Cyclic Prefix (CP)-OFDM.

23. (canceled)

24. (canceled)

25. The method of claim 16, wherein the indication is sent in Downlink Control Information (DCI) or Radio Resource Control (RRC).

26. The method of claim 25, wherein the DCI or RRC indicates a first DMRS port associated with a first SRS resource set and a second DMRS associated with a second SRS resource set.

27. The method of claim 16, wherein a same Code Division Multiplexing (CDM) group is used for all the DMRS ports or SRS resource sets or different CDM groups are used for all the DMRS ports or SRS resource sets.

28. (canceled)

29. (canceled)

30. (canceled)

31. A user Equipment (UE), comprising processing circuitry and network interface, the processing circuitry being configured to:
receive, from a network node, a configuration of a plurality of sounding reference signal (SRS) resource sets for physical uplink shared channel (PUSCH) transmissions with multiple layers using Discrete Fourier Transform (DFT)-Spread (S)-Orthogonal Frequency Division Multiplexing (OFDM);
receive an indication from the network node, the indication comprising one or more Demodulation Reference Signal (DMRS) ports mapped to the plurality of SRS resource sets; and
send simultaneously a PUSCH transmission based on the indication, from each panel of the plurality of panels, wherein each panel is associated with a SRS resource set of the plurality of SRS resource sets.

32. (canceled)

33. (canceled)

34. (canceled)
